(19) United States
(12) Patent Application Publication
(10) Pub. No.: US 2003/0012214 A1
(43) Pub. Date: Jan. 16, 2003

(54) Hybrid time switch as a rotator tandem

(75) Inventor: Ernst A. Munter, Kanata (CA)

Correspondence Address: Swabey Ogilvy Renault, 1600-1981 McGill College Avenue, Montreal, QC, H3A 2Y3, CA

(73) Assignee: Nortel Networks Limited

(21) Appl. No.: 09/900,189

(22) Filed: Jul. 9, 2001

(51) Int. Cl. H04L 12/54

(52) U.S. Cl. 370/429; 370/412

(57) ABSTRACT

A hybrid switch comprises a common data memory for storing information units (IUs) at memory addresses dictated to a time slot associated with a source channel of the IU. A control memory stores time slot numbers in memory addresses dedicated to the outgoing channels. The IUs stored in the data memory are read out under control of the control memory. The control memory is read sequentially to service each output channel. The hybrid switch may serve both synchronous transfer and packet traffic, while permitting multicast. The hybrid switch is useful in a rotator-type (commutated) switch for both packet switching and as a time division multiplexed (TDM) switch/cross connect. Incoming packet and TDM information is segmented into fixed length IUs with a header portion containing destination routing information (e.g. outgoing port of channel). The advantage is a switch with the simple, non-blocking characteristics of a rotator and the adaptability to be used for multicasting.

### CROSS-REFERENCE TO RELATED APPLICATIONS

This is the first application filed for the present invention.

### MICROFICHE APPENDIX

Not Applicable.

### TECHNICAL FIELD

The present invention relates in general to switching in telecommunications networks. In particular, it relates to a hybrid switch that permits some switch ports to operate in synchronous transfer mode and others to operate in packet mode.

### BACKGROUND OF THE INVENTION

In a simple commutated switch or rotator, a pair of NXN commutators are cyclically shared, typically among N input/output ports. Two common applications of the rotator design have been for switching TDM (time division multiplexing) channels organized in frames, and for packet switching.

As illustrated in FIG. 1, a conventional TDM time slot interchange switch 60 (“time switch”) switches information units (IUs) received from port+channel “s” at time slot “s” to port+channel “d” at time slot “d”. For ease of comparison, switch 60 is configured to switch TDM payloads. The TDM payload is bundled into IUs that include the payload data (e.g. pulse code modulated (PCM) data) and, optionally a header portion including routing information. Time switch 60 requires a connection control memory 66 to be loaded via a control processor 70 with static or infrequently changing connection control information that defines the source port+channel to destination port+channel connectivity. IUs received via a bus 61 are written into a data memory 62 in a fixed (e.g. sequential) order defined by a time slot counter 64 and read out under control of the connection information. Control memory 66 is read in fixed (sequential) order defined by time slot counter 64 and the data output from control memory 66 provides the read addresses for data memory 62 for the current time slot. IUs read from the address supplied by control memory 66 are sequentially output on bus 63, one per output channel.

In a conventional packet rotator switch 60a as illustrated in FIG. 2, destination information in the headers of each packet received by an inlet port is forwarded via bus 61a which may be segmented into smaller IUs or moved without segmentation to a location in data memory 62a dedicated to a respective output port. IUs are read out in a fixed (e.g. sequential) cycle defined by time slot counter 64a to deliver the IUs to their respective destination ports via bus 63a, at one per time slot.

Two key differences between time switch 60 and packet switch 60a are the use of the control memory 66 in time switch 60 to determine connectivity, and the different modes of accessing the data memory 62 and 62a when writing or reading. In time switch 60, data memory 62 is written sequentially and read randomly, so that payload data stored in data memory 62 is stored at addresses associated with the originating input port and channel. An opposite strategy is used for packet switch 60a, in that data memory 62a is written randomly and read sequentially so that payload data stored in data memory 62a is stored at addresses associated with the destination port.

U.S. Pat. No. 5,144,619 (Munter) which issued Sep. 1, 1992 describes a common memory switch for routing data signals derived from asynchronous transfer mode (ATM) and synchronous transfer mode (STM) cells, as does U.S. Pat. No. 5,390,184 (Morris) issued Feb. 14, 1995. While the switch disclosed in the respective references is a hybrid circuit that permits some ports to operate in TDM (i.e. STM) mode and others in ATM, the switches rely on a mode selection to route the STM or ATM cells differently. Moreover, in '619 to Munter, STM data is stored in an STM data memory in accordance with conventional strategies in which the data is stored at addresses indicative of the data's source port+channel, while the ATM data is stored differently. There is no suggestion in either reference to use the respective switch in a rotator implementation.

U.S. Pat. No. 5,862,136 (Irwin) which issued Jan. 19, 1999 describes a telecommunications apparatus for transporting ATM cells having either isochronous units of payload data or asynchronous units of payload data between receiving and transmitting ports. A buffer is provided for asynchronously queuing units of payload data received and for subsequently transmitting the queued units in a TDM data stream toward the transmitting ports. A time slot interchanger is used to reorder a time defined sequence of isochronous units of payload data from the first data stream into a second time defined sequence of isochronous units of payload data in a second TDM data stream. An outgoing TDM data stream is assembled by transferring the first data stream into the outgoing data stream while substituting each payload occurrence of isochronous units from the second TDM data stream into corresponding TDM locations in the outgoing data stream. The outgoing data stream is transmitted toward the transmitting ports. Telephone connections are supported by the isochronous units of payload data.

U.S. Pat. No. 6,167,041 (Afanador), which issued Dec. 26, 2000 describes a hybrid switch with a flexible link list manager for switching ATM or STM traffic. The switch further includes an input hybrid page, an output hybrid page and a hybrid routing table for managing the time slot interchange function. The STM data stream is segmented to form fixed length, serially propagating digital data segments. The time frame length (and overall byte length) of each STM data segment is equal to the ATM cell length. The ATM cells as well as the STM segments are processed synchronously and mapped to output ports with reference to port address information stored in a hybrid routing table.

Associated with each input port is at least one entry in the hybrid routing table where STM switching is specified along with an output port. A link list manager links the input data to a queue associated with the output ports. For synchronous traffic, the queues have a depth of one since output contention is not an issue for STM switching. ATM switching uses the VPI/VCI number in each cell and the information stored in the hybrid routing table to map cells from the input to the output. Contending ATM cells are processed in a queue by the link list manager. The link list manager creates queues based on the output port and the class of service. Unlimited multicasting for ATM traffic is supported in the same way as it is for STM traffic, by linking cells to multiple output queues. Although the ATM cells are propagated asynchronously in the serial domain outside of the switch, the ATM cells are processed synchronously along with the STM segments in the parallel domain within the switch. The switch can support any network distribution of STM and ATM traffic.

A rotating ATM/STM packet switch is described in U.S. Pat. No. 5,168,492 (Beshai et al), which issued Dec. 1, 1992. Under control of an input rotator, packetized data is written to a data memory dedicated to the destination outlet identified in the header for the packet. The packet optimized version of the rotator is not directly suitable for operation in TDM mode. In effect it requires asynchronous packetizing of TDM streams and requires buffering and recovery of synchronicity. Furthermore, it is not adapted to provide multicasting or broadcasting. Multicasting is required in a TDM cross-connect application for hitless protection switching. Multicast and broadcast are also features required for efficient video distribution.

Therefore there exists a need for a rotator switch that permits some switch ports to operate in TDM mode and others to operate in packet mode. It is further desirable that the switch retain the ability to statically assign the connections between TDM ports, including the ability to set up multicast and broadcast connections.

### SUMMARY OF THE INVENTION

It is an object of the invention to provide a hybrid switch as a rotator tandem.

Accordingly, an aspect of the present invention provides a hybrid switch for a rotator switch system for switching data among m inlets and n outlets, each inlet having an inlet peripheral for generating IUs from said data, each outlet having an outlet peripheral for reforming said data from said IUs and where the rotator switch system comprises p of said hybrid switches and one or more rotators cyclically connecting said p hybrid switches between said m inlets and said n outlets, each of m, n and p being an integer. The hybrid switch comprises m data memories organized by inlet for storing an IU; n control memories organized by outlet for storing an IU location in the data memories; and means for reading to the i^{th} outlet an IU at an IU location in the data memory specified by the i^{th} control memory, the i^{th} outlet being only connected to the means for reading of each of said p hybrid switches as the at least one of said rotators cyclically connects the p hybrid switches and n outlets, where i=I to n.

According to an other aspect of the invention, there is provided a rotator switch system for switching data among m inlets and n outlets, m and n being integers. The rotator switch system comprises m inlets, each having an inlet peripheral for generating IUs from the data; p hybrid switches, p being an integer, each hybrid switch having m data memories organized by inlet for storage of a IU and having n control memories organized by outlet for holding IU storage information; an input rotator cyclically connecting the m inlets and the p hybrid switches; n outlets, each having an outlet peripheral for reforming the data from the IUs; and an output rotator cyclically connecting the p hybrid switches and the n outlets, the i^{th} outlet being only connected via the i^{th} control memory location to a data memory location of each of the p hybrid switches as the output rotator cyclically connects p hybrid switches and n outlets, where i=I to n.

In yet a further aspect of the invention, there is provided a method of switching data in IUs from a plurality of inlets to selected ones of a plurality of outlets, each said IU comprising a header having destination routing information and a payload comprising either ATM data or STM data. The method comprises the steps of receiving the IUs one-by-one from the plurality of inlets in an order such that the source inlet from which each IU originates is determinable; for each IU received, storing the IU in a data memory means at a data memory address indicative of the source inlet for the IU and storing the data memory address for the IU in a control memory means at a control memory address assigned to the destination outlet for the IU indicated by the destination routing information of the IU; and transmitting the IUs to the outlets one-by-one, each IU read from the data memory at a data memory address read one-by-one from the control memory means.

Preferably, when at least some of the inlets receive STM data and the remainder ATM data and at least some of the outlets transmit STM data and the remainder ATM data, the method includes additional prior steps. The steps comprise:

(a) accumulating STM data incoming from an inlet receiving STM data;

(b) adding a header to a pre-defined amount of accumulated STM data under step (a) to form a IU, said header comprising pre-programmed information indicating a destination outlet;

(c) receiving ATM data incoming from an inlet receiving ATM data;

(d) adding a header to a pre-defined amount of ATM data received under step (c) to form a IU, said header indicating a destination outlet; and

(e) presenting IUs one-by-one in an order such that the inlet from which each IU originates is apparent.

According to an aspect of the method, the method may include steps for multicasting data. The method may including the step of managing the control memory means for multicasting to stop transmitting a IU originating from an inlet to a multicast destination outlet following a time period after which IUs from the inlet no longer identify the multicast destination outlet. Preferably, the step of managing the control memory means comprises storing in the control memory means at an address for the multicast destination outlet a data memory address for a predefined idle IU. Moreover, the method may include the step of multicasting data from a selected inlet receiving STM data to a set of multicast destination outlets comprising managing a set of multicast destination outlets; programming said pre-programmed routing information for each of said destination outlets to populate the control memory means at the addresses indicated by the destination outlets with an address of the data memory indicative of the source inlet; and regularly refreshing said pre-programmed routing information from said set of multicast destination outlets to refresh the population of the control memory means.

Derivation of both types of product (TDM switch/TDM cross connect and packet switch) from the same core technology is desirable as it results in manufacturing, documentation, and inventory efficiencies. It is further desirable to achieve flexibility and potential operational efficiency when a packet switch and a fiber cross-connect switch are tightly coupled. In this scenario, a large number of fiber links may converge on a given node. Some of these fibers (or wave-lengths within fibers) carry packet traffic to be switched as packets at this location, others (while still perhaps carrying packet traffic) merely need to be cross connected to reach some switch at another node location. While the latter could be switched at the present node, this would be unnecessary since all the traffic on that fiber is destined to the same other location and hence can bypass the switch at the present node. The combined switch permits rapid electronic rearrangements of this nature to follow traffic patterns over time, without the need to deploy and manage two different types of equipment. Furthermore, the ratio of bypass and switched traffic may be easily adjusted electronically via automatic provisioning.

### BRIEF DESCRIPTION OF THE DRAWINGS

Further features and advantages of the present invention will become apparent from the following detailed description, taken in combination with the appended drawings, in which:

FIG. 1 is a schematic diagram of a conventional time slot interchange (time division multiplex switch)

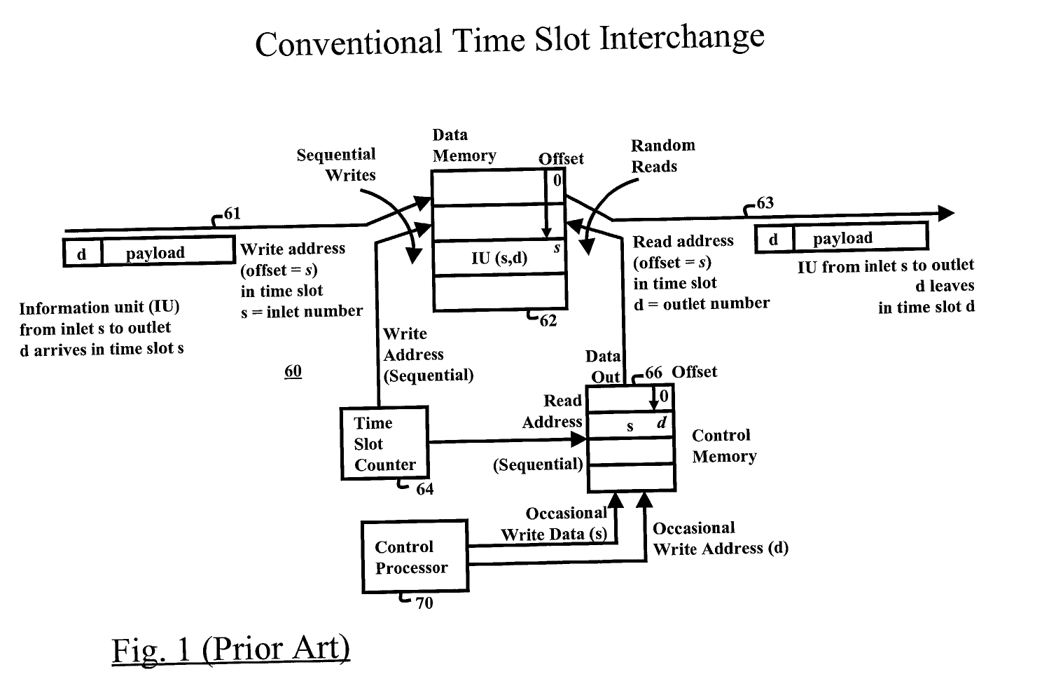

FIG. 2 is a schematic diagram of a conventional packet switch;

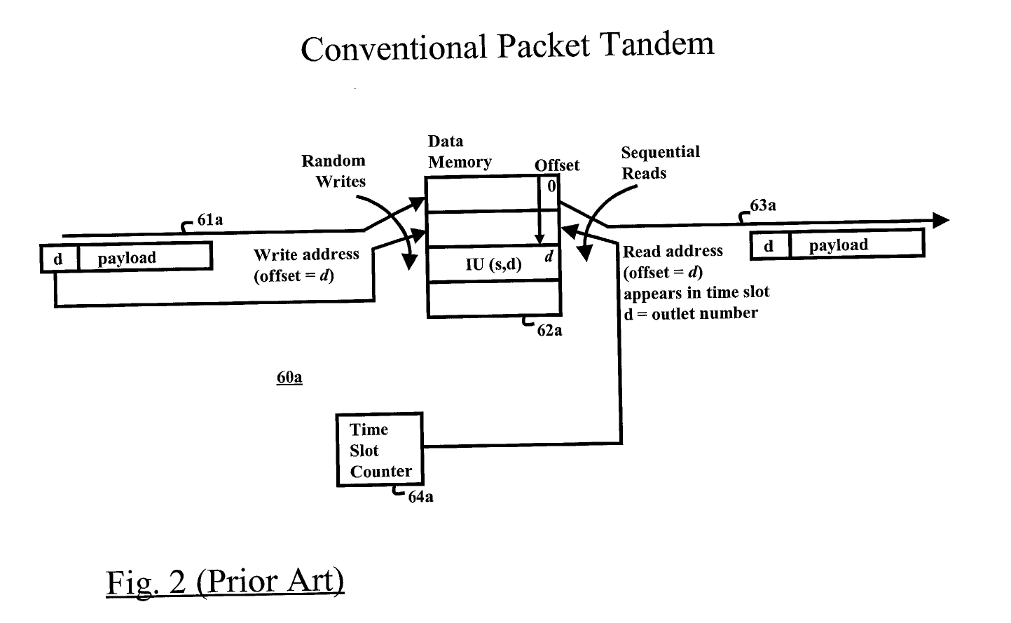

FIG. 3 is an exemplary embodiment of a hybrid switch in accordance with the invention, showing operation in both TDM and Packet modes;

FIG. 4 illustrates a hybrid switch rotator system in accordance with the invention using the hybrid switch coupled between two n×n commutators;

FIG. 5 illustrates switch inlet and outlet peripherals for the hybrid rotator switch in accordance with the invention;

FIG. 6 illustrates a further embodiment of the hybrid switch in accordance with the invention, showing TDM multicast;

FIG. 7 is a schematic illustration of a multiplexed hybrid rotator system in accordance with another embodiment of the invention; and

FIG. 8 is yet a further configuration of rotator tandems in accordance with the invention, arranged as staged rotators for large networks.

It will be noted that throughout the appended drawings, like features are identified by like reference numerals.

### DETAILED DESCRIPTION OF THE PREFERRED EMBODIMENT

The invention provides a hybrid time switch configured as a rotator tandem. Input and output peripherals (1/0 ports) of the switch process payload data into information units (IUs) of fixed length. Each IU contains a header that includes an identifier associated with an output port. IUs are sequentially written to a common data memory at a location governed by input port/channel during a corresponding time slot. IUs are randomly read from the common memory and transferred to an output port during a corresponding time slot. The random reads are controlled by read addresses sequentially written to a control memory at a location governed by the time slots which likewise correspond to the output ports. The switch supports both synchronous and asynchronous transfer modes. In asynchronous transfer mode, contention is resolved by the input ports before IUs are sent to the data memory.

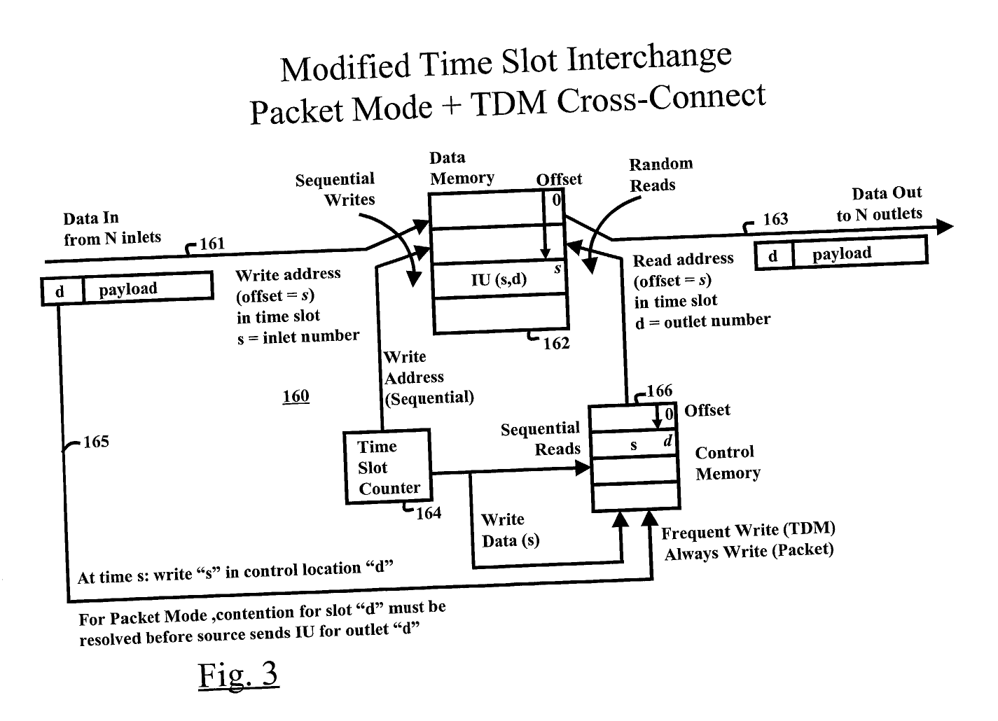

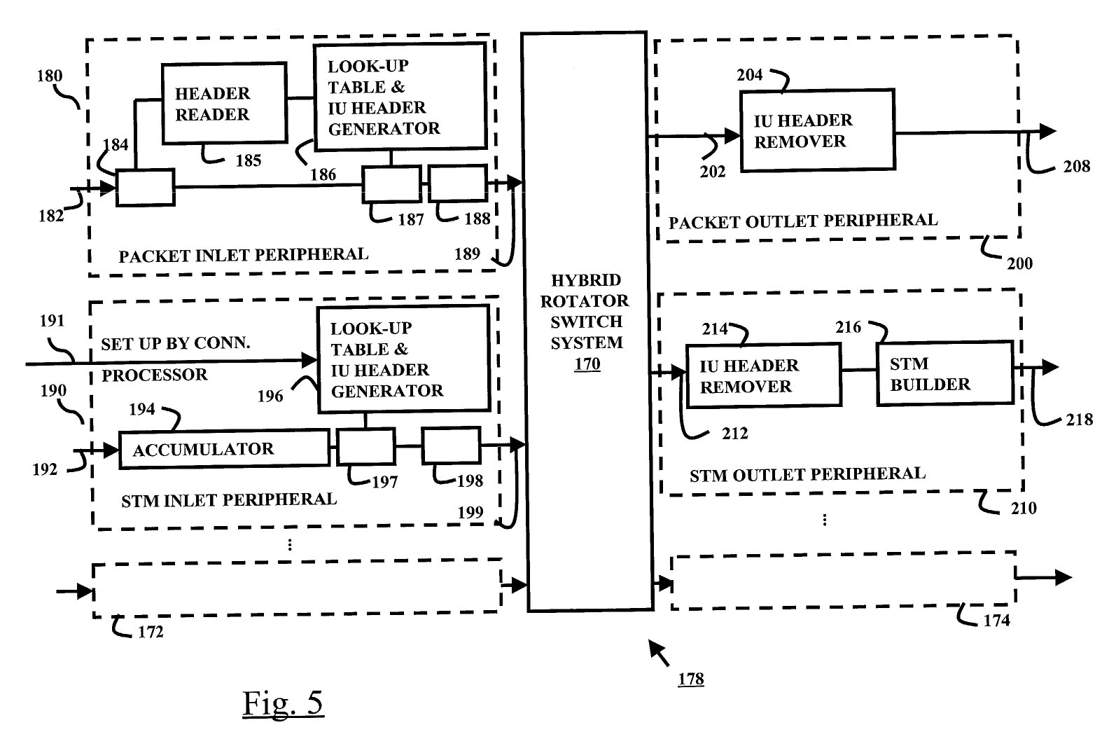

FIG. 3 illustrates an exemplary hybrid switch in accordance with the invention. A hybrid switch 160 is configured to receive payload data from m input ports and to switch the payload to n output ports, where m and n are positive integers. The payload received by the input ports, may be in TDM (STM) or packet (e.g. ATM) protocol format. In either case, the payload is processed to form information units (IUs) that include a fixed-length payload portion and a header portion that stores destination routing information, as described in more detail below with reference to FIG. 5.

Switch 160 has a common data memory 162 for storing incoming IUs received via bus 161. Time slot counter 164 is coupled to the write address of data memory 162 and to both a read address and a data input of a control memory 166. An IU header is provided via bus 165 to a write address of control memory 166. A data output of control memory 166 is coupled to a read address of data memory 162, and a data output of data memory 162 is coupled to bus 163.

Time slot counter 164 is a cyclical integer counter that resets each time it counts to “m-1”. Counter 164 provides the write address from data memory 162 such that each IU, whether originating from a TDM or ATM connection, is written to data memory 162 at an address indicative of the IU's source port number “s”. Each IU received on bus 162 includes a header portion containing destination routing information for control memory 166. The destination routing information includes the output port number “d” for the IU, and provides a write address used to write the current time slot counter value “s” into control memory 166. Control memory 166 thus provides a look-up table used to locate the address “s” of data memory 162 where an IU was stored for retrieval and transmission to a particular destination port number “d”.

Time slot counter 164 further provides a read address for accessing the output ports sequentially. The data output of control memory 166 provides read addresses for data memory 162. At each time slot “d”, the contents of address “d” of data memory 162 are read to retrieve the address “s” used to access data memory 162. Data read from data memory 162 is output on bus 163 to the output ports (not shown).

Control memory 166, on the other hand, is not written sequentially. An output of time slot counter 164 is connected to the data input of control memory 166 such that the current count is stored at an address determined by the destination port and channel (i.e. outlet number) of the current IU. Control memory 166 serves as a dynamic look-up table indexable by destination outlet number that indicates, for a given outlet the read address of data memory 162, where the IU to be switched is stored.

Due to the nature of synchronous payload connections such as TDM voice traffic, the outlet number for IUs received at a given source port may not vary as frequently as it does for packet traffic. Thus, control memory 166 may not need to be written with the inlet number every time an IU is received from a given source port. However, in a preferred embodiment, ATM and TDM switching operates in the same manner and the control memory is updated with each IU received.

Also during each time slot, an IU is read out of data memory 162 for transmission over bus 163. Time slot counter 164 provides its current count as a read address of control memory 166 so that each outlet is accessed sequentially, provided m=n. A second counter may be used to count the n output ports before cycling if m is not equal to n. During time slot “d”, the dth outlet is accessed by reading the dth address of control memory 166 to obtain the source inlet number “s”, which is the read address for data memory 162. The output of control memory 166 is connected to the read address of data memory 162. This results in a read of an IU from data memory 162 that originated from inlet “s”.

Unlike STM traffic, data packet traffic may give rise to output contention problems, where more than one asynchronous packet contends for the same outlet during the same cycle of time slot counter 164. The preferred embodiment of switch 160 presumes that contention for output time slot “d” is resolved in a manner well known in the art before a source inlet sends an IU for destination “d”.

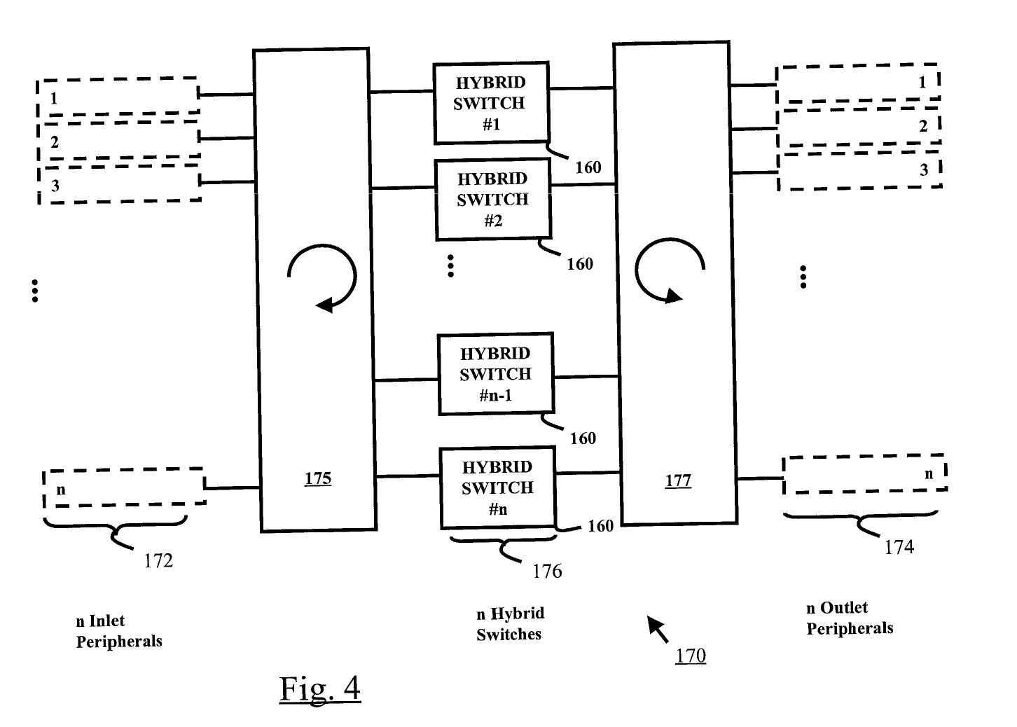

FIG. 4 illustrates a hybrid switch rotator system 170 in accordance with the present invention. A set 176 of n hybrid switches 160 each coupled between an n×n input rotator or commutator 175 and an n×n output rotator or commutator 177 known in the art and described, for example, in '492 of Munter, the specification of which is incorporated herein by reference. The commutators 175, 177 serve to connect the hybrid switches 160 to respective sets 172 and 174 of n inlet and n outlet peripherals. While hybrid switch rotator system 170 is described for switching n inlets to n outlets, it is understood that system 170 may be configured with p hybrid switches to serve m inlets and n outlets where m, n and p are positive integers.

As described further with reference to FIG. 5 below, IUs processed by an inlet peripheral are queued in a FIFO queue. The output of the FIFO queue is connected to a particular hybrid switch 160 via input commutator 175 during one time slot and over the full cycle of the commutator to each of the n hybrid switches in turn, one hybrid switch 160 per time slot. During a time slot, the IU at the head of the FIFO of an inlet peripheral is transferred to hybrid switch 160 to which it is coupled. The IU is stored in the data memory 162 (FIG. 3) of a hybrid switch 160 at an offset dedicated to the source inlet of the IU, as indicated by the time slot counter 164 (FIG. 3) of the respective hybrid switch 160. The source port number generated by the counter 164 of the respective hybrid switch 160 is stored in associated control memory 166 at an offset defined by the outlet number stored in the IU header. Preferably, a contention resolution manager (not shown) operates to avoid overwriting the data memory 162 of the hybrid switch 160 before the last IU provided to the same location is output. If contention is detected, the FIFO queue retains the IU for transfer to the next hybrid switch 160 during the next time slot. The rotator advances one position so that each inlet peripheral is connected to a different hybrid switch 160 in a cyclical rotation. Each inlet peripheral delivers the IU stored at the head of its FIFO to a hybrid switch 160, unless contention is detected, as described above. This distribution of IUs guarantees a proper order of IU delivery to each connection, routed through the hybrid switch rotator switch system 170.

Each time the set 176 of hybrid switches 160 receives IUs, the set 176 transmits IUs through the output commutator 177 to the set 174 of n outlet peripherals. During a time slot, a hybrid switch 160 transfers an IU identified by the control memory 166 at an offset of the control memory 166 indicated by the time slot counter 164 to an outlet peripheral 174 connected to the hybrid switch 160. If the contention resolution manager (not shown) withheld an IU transfer due to IU contention, the control memory and/or data memory may be empty, in which case a null IU is transferred.

FIG. 5 illustrates a switching system 178 in accordance with the invention, showing the inlet and outlet peripherals 172 and 174 in more detail. An exemplary packet (e.g., an ATM cell) inlet peripheral 180 is connected between an ATM input port 182 and switch inlet 199. An exemplary STM inlet peripheral 190 is connected between STM input port 192 and switch inlet 189. STM inlet peripheral 190 is further connected to a connection control processor (not shown) associated with STM input port 192 via set-up processing link 191. An exemplary packet outlet peripheral 200 is coupled between a switch outlet 202 and an ATM output port 208. An STM outlet peripheral 210 is coupled between a switch outlet 212 and an STM output port 218.

Packet inlet peripheral 180 includes a splitter 184 connected to ATM input port 182 for splitting input cells and sending a header of each cell to a header reader 185, and the cell payload to a combiner 187. The header reader 185 is coupled to a look-up table and header generator 186, an output of which is coupled to an other input of combiner 187. The output of combiner 187 is connected to FIFO queue 188. Switch inlet 189 is connected to the output of FIFO queue 188. Packet outlet peripheral 200 includes an IU header remover 204 coupled between switch outlet 202 and ATM output port 208. An output FIFO queue (not shown) may precede header remover 204, if necessary. The function of each of these components is described below in more detail.

STM inlet peripheral 190 includes an accumulator 194, the input of which is connected to STM input port 192 and the output of which is connected to one input of a combiner 197. STM inlet peripheral 190 further includes a look-up table and header generator 196 connected to receive input from a connection processor (not shown) via link 191 and to output a header to combiner 197. The output of combiner 197 is connected to FIFO queue 198. Switch inlet 199 is connected to the output of FIFO 198. STM outlet peripheral 210 comprises an IU header remover 214 the input of which is coupled to switch outlet 212 and the output of which is coupled to STM builder 216. STM port 218 is coupled to the output of STM builder 216. An output FIFO queue (not shown) may precede header remover 214, if necessary. The function of each of these components is likewise described below in more detail.

Each of the packet inlet peripherals 180 receives packets according to known protocols, for example, in an ATM cell format where each cell comprises an ATM header and ATM payload. It is the task of the inlet peripheral to format fixed length IUs from packets received (e.g., ATM cells). Depending on the length of an input packet (which length may be variable) one or more IUs may be formatted from a single packet. A packet header includes a destination connection identifier indicating the destination of the packet. Incoming packets are directed by splitter 184 to header reader 185 and to combiner 187. Header reader 185 reads the ATM header of the packet and passes header information to look-up table and header generator 186. Look-up table and header generator 186 determines the switch outlet 202 to which IUs for a given packet will be directed using a destination connection identifier in the packet header as an index for a look-up table. The switch outlet number thus determined is placed in an IU header and output to combiner 187, which combines the IU header with at least a part of one or more incoming packets to form an IU. It may be necessary to pad a received portion of a packet to construct a fixed length IU, as is well understood in the art. A formatted IU is placed in FIFO queue 188 for transfer via switch inlet 189 in accordance with the cycle of input rotator 175. Keep, null or idle IUs may be inserted when there is no packet traffic to be processed by packet inlet peripheral 180 so that hybrid switch 160, which operates synchronously, always receives an IU.

IUs transferred from hybrid switch 160 in a sequence dictated by the cycle of output commutator 177 to a switch outlet 202 configured for packet traffic are deconstructed by header remover 204 to remove the IU header, and output the packets in the condition in which they were received, through output port 208. Though not shown, a packet builder may construct a packet from more than one IU, if required.

Each STM inlet peripheral 190 receives STM data on incoming port 192. Accumulator 194 may accumulate the STM data to fill the IU payload, which is of a pre-determined size, and passes the IU payload to the combiner 197. Look-up table and header generator 196 generates an IU header containing the destination switch outlet to which the IU is to be directed by hybrid switch 160. Routing information is sent to the look-up table and header generator 196 by a connection control processor (not shown) via link 191 to control the routing of STM data.

Combiner 197 combines the IU header and IU payload and outputs the IU to FIFO queue 198. FIFO queue 198 transfers an IU at the head of its queue over switch inlet 199 to hybrid switch 160 as dictated by the cycle of input rotator 175. An IU transferred from a hybrid switch 160 through a switch outlet 202 is deconstructed by IU header remover 214. STM data from one or more IUs is assembled by STM rebuilder 216 for output through STM port 218.

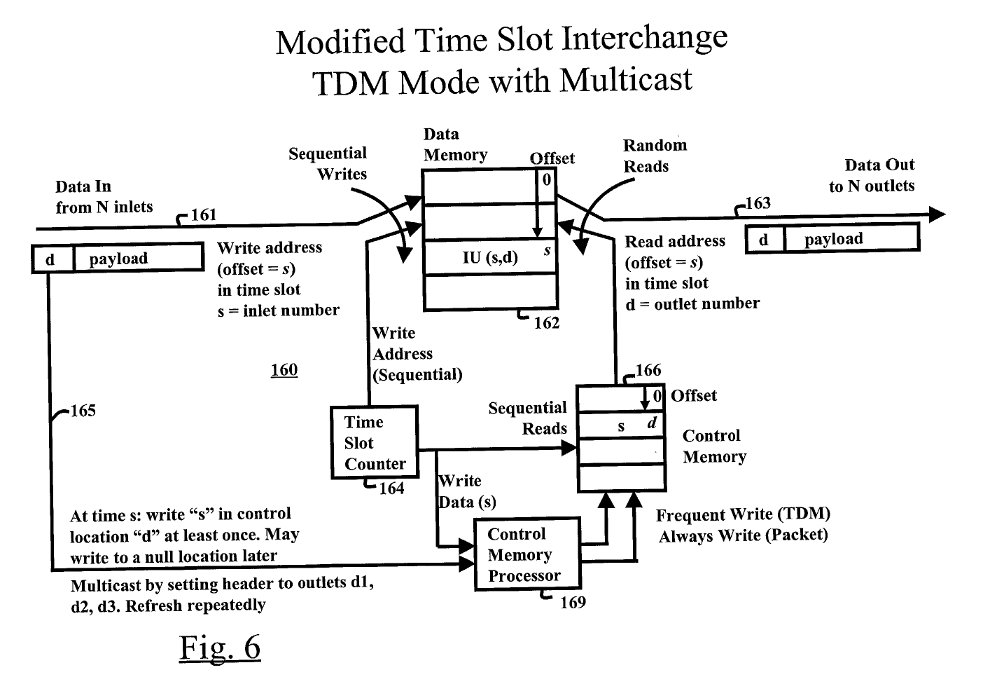

TDM payload traffic may be multicast using the rotator switch system in accordance with the invention. With reference to FIGS. 5 and 6, multicasting may be implemented by sequentially setting IU routing information in respective IUs from a single input source port to route the IUs to multiple output ports. The received header information is sequentially inserted in respective IUs at least once, and preferably in a continuous cycle. If STM data received via an inlet “s” is to be multicast to multiple outlets, for example “d1”, “d2”, and “d3”, successive IUs output by inlet “s” are constructed by the STM inlet peripheral 190, under control of an associated connection control processor (not shown) with respective IU headers containing the required outlet addresses “d1”, “d2”, and “d3”. Control memory 166 for each hybrid switch 160 is therefore populated with the “s” address at offsets “d1”, “d2” and “d3”. Thereafter, IUs from inlet “s” are efficiently written once at a location “s” of the data memory 162 and read three times for transmission to the respective outlets. As will be understood by persons skilled in the art, some initial IU loss may be suffered until each control memory 166 is populated, but the loss is nominal.

The connection control processor associated with STM inlet peripheral 190 includes a multicast destination memory (not shown) for managing a list of outlets to which the multicast STM data is to be transmitted. Multicast destination outlets are indicated to STM inlet peripheral 190, via link 191 for use by look-up table & header generator 186 where the outlet addresses are stored for insertion in the IU headers of sequential multicast payloads.

When it is determined that a particular destination (e.g. “d2”) is no longer to be a part of an ongoing multicast session, the multicast session must be maintained without interruption, to avoid an interruption of the multicast session for the remaining destinations. Although STM inlet peripheral 190 no longer forwards IUs intended for outlet “d2”, it cannot send an idle packet to “d2” or remove source inlet number “s” from address “d2” of control memory 166.

In order to stop the transfer of multicast traffic to outlet “d2”, hybrid switch 160 may be configured to direct idle IUs to the outlet “d2”. The data memory 162 may be provisioned with a null or idle IU at a pre-defined location (e.g. offset m), not otherwise addressable via time slot counter 164. The null IU is used to drop outlets from a multicast session as will be explained below with reference to FIG. 6. FIG. 6 illustrates the hybrid switch 160, shown in FIG. 3, with a control memory processor 169 coupled to receive the IU header via bus 165 and the current count from counter 164, and to write the count at the destination outlet offset of control memory 166. Control memory processor 169 may be configured to control control memory 166 for managing TDM multicast. For example, control memory processor 169 may be configured to direct idle IUs to destination outlets that have not specifically received IUs from any source inlet for a predetermined period of time (e.g., a specific number of time slots). Control memory processor 169 maintains a count of how many time slots have occurred since the location “d2” of control memory 166 was last updated. If the count exceeds a predetermined value, location “d2” may be written by control memory processor 169 with the address of data memory 162 reserved for idle IUs. With this configuration, the connection control processor associated with the STM inlet peripheral 190 from which the multicast traffic originates is configured to refresh the offsets of the control memory 166 for each specific destination outlet taking part in the multicast session using an IU header on a cycle that is more frequent than the count for each outlet maintained by control memory processor 169.

Typically, it is anticipated that each port 192, 218 of an STM peripheral 190 and 210 operates at the same speed. However, though not shown, a multiplex/demultiplex of several lower speed ports at any input 192 or outlet 218 may also be supported.

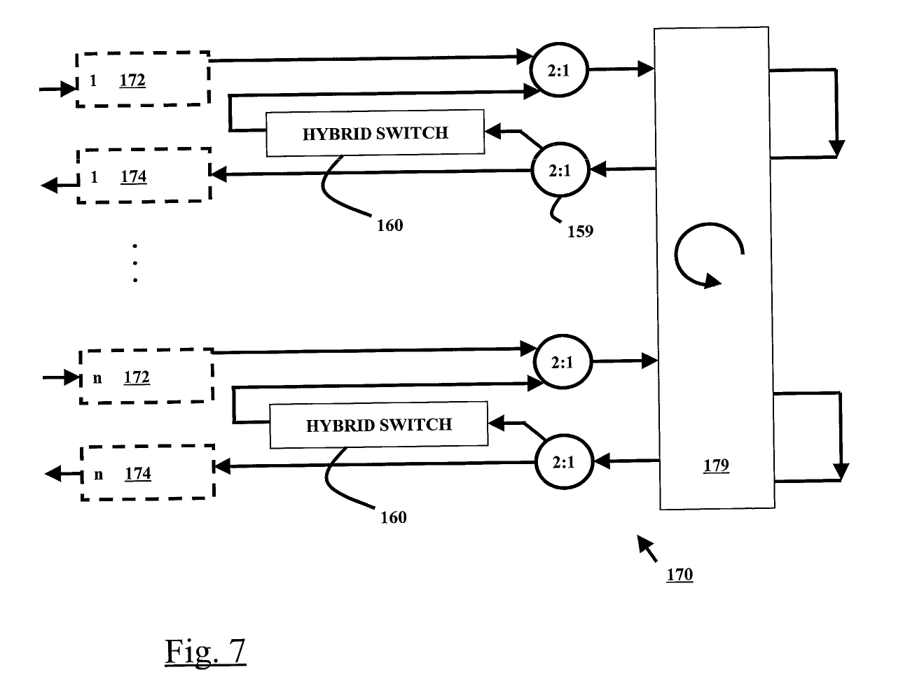

The rotator switch system 170 in accordance with the invention scales well to large switch applications. Expansion in the core (hybrid switch set 176) may be employed to ensure the hybrid rotator switch 170 is non-blocking, and to minimize delay. An alternative embodiment of hybrid rotator switch system 170 is illustrated in FIG. 7. A single n×n commutator 179 multiplexed/demultiplexed to function as the input and output rotators 175 and 177 shown in FIG. 5.

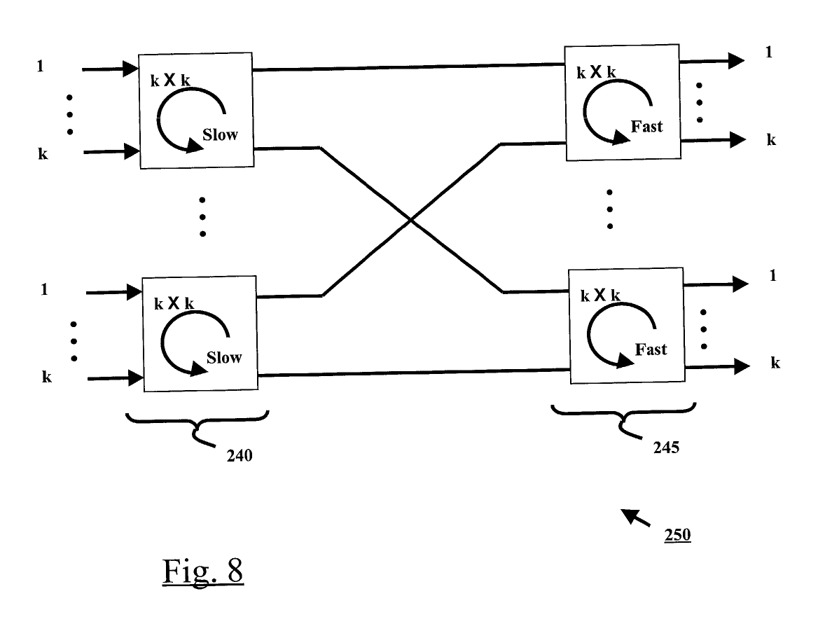

Further, for large networks, an n×n staged rotator system 250 may be implemented in two or more stages. As disclosed, for example, in '492 of Munter and shown in FIG. 8, smaller k×k rotators where k=<n may be used. Consequently, the number of units required is 2k rather than k² otherwise required for a square rotator. Second stage units 245 shift each time slot while first stage units 240 shift each k^{th} time slot. The number of clock-driven cross points per inlet and per outlet are respectively 2√n. Two-stage hybrid rotator switch system 250 in accordance with this embodiment provides complete n to n switching and is equivalent to a square hybrid rotator switch system 170.

The hybrid rotator switches in accordance with the present invention have the properties of a single multiplexed time switch (e.g. unconditionally non-blocking, unrestricted multicast capability) but with higher average transit delay which is proportional to the number of ports. Delay is also proportional to IU size. Some dilation (for example, increased bit rate, or other method) may be required to provide bandwidth for the IU headers. Packet switches generally deal with statistically varying traffic. Even though traffic shaping, admission control, packet discard and other techniques may be employed to avoid switch overload, it is still necessary to accommodate short term statistical variations in traffic flow (specifically, traffic converging on an output from multiple sources). For this reason, a practical rotator based packet switch also requires internal capacity dilation, either by increasing internal bit rates compared to the port bit rates, or by topological dilation, employing more tandem buffers than ports. Dilation is also one solution for compensating for payload packets that are of variable length, since the rotator principle relies on fixed-size packets. When variable-size packets are segmented into fixed-size IUs, there is an inevitable loss of efficiency due to the null padding that is inevitably required.

The hybrid switch in accordance with the invention provides a tandem switch useful as one of a set of tandem switches for coupling two n×n commutators. The entire switch can be used as a replacement for a space switch, in a packet mode of operation. By providing each tandem with connection information, a channelized TDM switch of large capacity can be expected. The capacity of the switch is limited only by the signal transit delay and memory requirements per tandem, which grow with total size.

The embodiment(s) of the invention described above is(are) intended to be exemplary only. The scope of the invention is therefore intended to be limited solely by the scope of the appended claims.

I claim:

1. A hybrid switch for switching payload data among m inlets and n outlets, each inlet having an inlet peripheral for generating Information Units (IUs) from said payload data, each outlet having an outlet peripheral for reforming said payload data from said IUs, comprising:
m data memories organized by inlet for storing the IUs;
n control memories organized by outlet for storing an address for each IU stored in the data memories; and
means for reading to an i^{th} outlet an IU from the data memories indicated by the address stored in the i^{th} control memory.

2. The hybrid switch as claimed in claim 1 wherein some of said m inlet peripherals comprise packet inlet peripherals others comprise synchronous transfer mode (STM) inlet peripherals and wherein some of said n outlet peripherals comprise packet outlet peripherals and others comprise STM outlet peripherals so that said hybrid switch operates in both packet and STM modes.

3. The hybrid switch as claimed in claim 1 wherein said hybrid switch synchronously transfers one IU per time slot.

4. The hybrid switch as claimed in claim 3 wherein the hybrid switch further comprises a first counter for providing a count each time an IU is to be stored in the data memories, said first counter restarting after counting m-1; and wherein the count of the first counter identifies an address of the data memories at which the IU is to be stored.

5. The hybrid switch as claimed in claim 4 further including a second counter for providing a count each time an IU is to be read to an outlet, said second counter restarting after counting to n-1; wherein the count of the second counter identifies the i^{th} control memory.

6. The hybrid switch as claimed in claim 5 wherein the first counter and the second counter comprise a single counter.

7. The hybrid switch as claimed in claim 1 further comprising a control memory processor coupled to the control memories for managing multicasting of IUs.

8. A rotator switch system for switching payload data among m inlets and n outlets, m and n being integers, the system comprising:
m inlets, each having an inlet peripheral for generating information units (IUs) from the payload data;
p hybrid switches, p being an integer, each hybrid switch having m data memories organized by inlet for storage of an IU and having n control memories organized by outlet for storage of an address for retrieving an IU stored in the data memories;
an input rotator cyclically connecting the m inlets and the p hybrid switches;
n outlets, each having an outlet peripheral for reforming the payload data from the IUs retrieved from the data memories; and
an output rotator cyclically connecting the p hybrid switches and the n outlets, the ith outlet being only connected to the data memories via the i^{th}control memory of each of said p hybrid switches as the output rotator cyclically connects p hybrid switches and n outlets, where i=o to n-1.

9. The rotator switch system as claimed in claim 8 wherein some of said m inlet peripherals comprise packet inlet peripherals and others comprise STM inlet peripherals and wherein some of the n outlet peripherals comprise packet outlet peripherals and others comprise STM outlet peripherals so that said rotator switch system operates in both packet and STM modes.

10. The rotator switch system as claimed in claim 8 wherein the inlet peripherals, outlet peripherals, rotators and hybrid switches synchronously transfer one IU per time slot.

11. The rotator switch system as claimed in claim 10 wherein each hybrid switch further comprises a first counter for providing a count each time an IU is to be stored in the data memories, the first counter restarting after counting to m-1; and wherein the count of the first counter provides an address of the data memories at which the IU is to be stored.

12. The rotator switch system as claimed in claim 11 wherein each hybrid switch further comprises a second counter for providing a count each time an IU is to be read to one of the outlets, the second counter restarting after counting to m-1; the count of the second counter identifying the ith control memory.

13. The rotator switch system as claimed in claim 12 wherein m=n=p and the first and second counters comprise a single counter.

14. The rotator switch system as claimed in claim 8 wherein at least one inlet peripheral comprises an STM inlet peripheral controlled by a connection control processor for multicasting data, said connection control processor having a multicast memory for managing multicast outlet information.

15. The rotator switch system as claimed in claim 8 further comprising, for each hybrid switch, a control memory processor coupled to the control memories for controlling the multicasting of the IUs.

16. The rotator switch system as claimed in claim 8 wherein m=n=p.

17. The rotator switch system as claimed in claim 16 wherein each of the input and output rotators comprises two tandem-connected sets of k×k rotators where k=√n, the number of k×k rotators in each set being k, and one set of rotators operates k times faster than the other set.

18. The rotator switch system as claimed in claim 16 wherein the rotators comprise a single rotator that is time multiplexed to function as an input rotator connecting the m inlets to the p switches at a first time period and as an output rotator connecting the n outlets to the p switches at a second, subsequent time period.

19. A method of switching data in information units (IUs) from m inlets to selected ones of n outlets, each IU comprising a header having outlet information and a payload comprising one of packet and STM data, the method comprising steps of:
sequentially receiving the IUs from the m inlets in an order such that the source inlet from which each IU originates is predetermined;
storing the respective IUs in a data memory at a data memory address associated with the inlet for the IU;
storing the data memory address for the IU in a control memory at a control memory address dedicated to an outlet indicated by the outlet information in the IU header; and
sequentially transmitting the respective IUs to the outlets, each IU being read from the data memory at a data memory address retrieved from the control memory.

20. The method as claimed in claim 19 wherein the method further comprises a step of counting at a first counter to generate the data memory address and, restarting the first counter after counting to m-1, wherein the step of storing the IU comprises storing the IU at a data memory address associated with a current count of the first counter and the step of storing the data memory address stores the current count in the control memory.

21. The method as claimed in claim 20 wherein the method further comprises a step of counting at a second counter to generate a control memory address each time an IU is to be transmitted and restarting the second counter after counting to n-1; wherein the step of transmitting comprises sequentially reading the control memory at a control memory address indicated by the second count.

22. The method as claimed in claim 19 further comprising a step of receiving STM payload data at some of the inlets receiving packet payload data at others of the inlets, and transmitting STM payload data from some of the outlets and transmitting packet payload data from others of the outlets.

23. The method as claimed in claim 22 further comprising steps of:
(a) accumulating STM data at an inlet receiving STM payload data;
(b) adding a header to a predetermined amount of accumulated STM payload data to form an IU, the header including information indicating an outlet;
(c) accumulating packet payload data from an inlet receiving packet payload data;
(d) adding header information to a pre-defined amount of packet payload data to form an IU, said header information indicating an outlet; and
(e) sequentially presenting IUs for transfer to the data memories in an order such that the inlet from which each IU originates is predetermined.

24. The method as claimed in claim 22 further including steps of:
managing a list of multicast outlets;
inserting in the IU headers information associated with each of the multicast outlets to form multicast IUs for populating the addresses of the control memory dedicated to the multicast outlets with an address of the data memory associated with an inlet supplying payload data to the multicast outlets.

25. The method as claimed in claim 24 comprising a step of:
periodically refreshing the routing information for each of the multicast outlets remaining in the list by populating the IU headers with addresses of the outlets so that the addresses are re-stored in the control memory.

26. The method as claimed in claim 25 further comprising a step of:
removing the data memory address indicative of the selected inlet from the control memory address associated with a selected multicast outlet to drop the multicast outlet from a multicast session.

27. The method as claimed in claim 26 wherein the step of removing is performed after a predetermined time period in which IU headers no longer identify the multicast outlet to refresh the control memory.

28. The method as claimed in claim 27 wherein the step of removing comprises storing a data memory address associated with a null IU at the control memory address associated with the multicast outlet to be dropped from the multicast session.
